(19) United States
(12) Patent Application Publication
(10) Pub. No.: US 2026/0234019 A1
(43) Pub. Date: Aug. 13, 2026

(54) POSITIVE ELECTRODE MIXTURE, PRODUCTION METHOD FOR POSITIVE ELECTRODE MIXTURE, AND LITHIUM-ION BATTERY

(71) Applicants: IDEMITSU KOSAN CO.,LTD., Chiyoda-ku, Tokyo (JP); NATIONAL INSTITUTE OF ADVANCED INDUSTRIAL SCIENCE AND TECHNOLOGY, Chiyoda-ku, Tokyo (JP)

(72) Inventors: Yuta FUJII, Chiyoda-ku, Tokyo (JP); Hiroyuki HIGUCHI, Chiyoda-ku, Tokyo (JP); Yamato HANIU, Chiyoda-ku, Tokyo (JP); Hikari SAKAEBE, Tsukuba-shi, Ibaraki (JP); Kentaro KURATANI, Tsukuba-shi, Ibaraki (JP)

(73) Assignees: IDEMITSU KOSAN CO.,LTD., Chiyoda-ku, Tokyo (JP); NATIONAL INSTITUTE OF ADVANCED INDUSTRIAL SCIENCE AND TECHNOLOGY, Chiyoda-ku, Tokyo (JP)

(21) Appl. No.: 19/469,442

(22) PCT Filed: Mar. 21, 2024
(86) PCT No.: PCT/JP2024/010947

§ 371 Date: Sep. 26, 2025

(30) Foreign Application Priority Data
Mar. 29, 2023 (JP) 2023-053718

(51) Int. Cl. C01G 23/00; H01M 10/0525; H01M 10/0562

(52) U.S. Cl. CPC C01G 23/007; H01M 10/0525; H01M 10/0562; C01P 2002/72; C01P 2006/40; H01M 2300/0068

(57) ABSTRACT

A positive electrode mixture comprising at least one of a titanium sulfide TiSₓ (2<x<10) and a discharge product of the titanium sulfide and a sulfide solid electrolyte having a diffraction peak for which 2θ is 20.1±0.4° in X-ray diffraction using a CuKα ray.

### TECHNICAL FIELD

The present invention relates to a positive electrode mixture, a production method for a positive electrode mixture, and a lithium-ion battery.

### BACKGROUND ART

In order to increase the energy density of a lithium-ion battery, the use of sulfur in a positive electrode active material is being studied. Since sulfur is an insulating element, a technique for imparting electron conductivity by compositing sulfur with a metal sulfide is being studied. For example, titanium polysulfide (TiSₓ: 2<x<10) obtained by compositing with titanium disulfide and sulfur has been developed as a positive electrode active material for lithium secondary batteries (Patent Document 1).

In addition, in order to enhance the lithium ion conductivity of a positive electrode, the compositing of titanium polysulfide and a solid electrolyte has been reported. As the solid electrolyte used for compositing, a sulfide solid electrolyte has been studied (Patent Document 1 and Non-Patent Document 1). Since the sulfide solid electrolyte is soft compared to an oxide solid electrolyte, an electrode-electrolyte interface having low resistance can be formed by compacting an electrode layer and the solid electrolyte layer.

### RELATED ART DOCUMENTS

### Patent Documents

Patent Document 1: JP 2014-093210 A

### Non Patent Documents

Non Patent Document 1: Solid State Ionics 262 (2014) 143-146

### SUMMARY OF INVENTION

A lithium-ion battery in which titanium polysulfide is used for the positive electrode cannot be said to have a high discharge capacity, and further improvement is required.

An object of the present invention is to provide a positive electrode mixture that enables a lithium-ion battery having a high discharge capacity, in which titanium polysulfide is used.

The present inventors found that the use of a positive electrode mixture obtained by combining a specific glass-ceramic solid electrolyte with titanium polysulfide makes it possible to obtain a lithium-ion battery having a high discharge capacity, and completed the present invention. The use of the specific glass-ceramic solid electrolyte makes it possible to obtain a lithium-ion battery having a high discharge capacity as compared with a solid electrolyte having the same specific elemental composition or a solid electrolyte having approximately the same ionic conductivity.

According to the present invention, the following positive electrode mixture and related items can be provided.
1. A positive electrode mixture comprising:
at least one of a titanium sulfide TiSₓ (2<x<10) and a discharge product of the titanium sulfide; and
a sulfide solid electrolyte having a diffraction peak for which 2θ is 20.1±0.4° in X-ray diffraction using a CuKα ray.
2. The positive electrode mixture according to 1, wherein the sulfide solid electrolyte comprises lithium, phosphorus, sulfur, and halogen as constituent elements.
3. The positive electrode mixture according to 1 or 2, wherein a content rate of lithium relative to all of the constituent elements of the sulfide solid electrolyte is 35 to 45 mol %.
4. The positive electrode mixture according to any one of 1 to 3, wherein a content rate a of the titanium sulfide, a content rate b of the sulfide solid electrolyte, and a content rate c of a conductive aid satisfy the following formulae (1) to (3).

$$10 mass \% \leq a \leq 90 mass \% \qquad ( 1 )$$

$$0 mass \% < b \leq 65 mass \% \qquad ( 2 )$$

$$0 mass \% \leq c \leq 40 mass \% \qquad ( 3 )$$

$$( a + b + c is 100 mass \% . )$$

5. The positive electrode mixture according to any one of 1 to 4, wherein in X-ray diffraction using a CuKα ray,
the positive electrode mixture has a diffraction peak for which 2θ is 20.1±0.4°, a diffraction peak for which 2θ is 34±1°, and
a diffraction peak for which 2θ is one or more selected from 15.5±1°, 44±1°, and 54±1°.
6. The positive electrode mixture according to 4, wherein the content rate c of the conductive aid is 0 mass %.
7. A production method for a positive electrode mixture, the method comprising a step of mixing a titanium sulfide TiSₓ (2<x<10) that satisfies the following (A) and a sulfide solid electrolyte that satisfies the following (B):
(A) in X-ray diffraction using a CuKα ray, the titanium sulfide has a diffraction peak for which 2θ is 34±1° and a diffraction peak for which 2θ is one or more selected from 15.5±1°, 44±1°, and 54±1°, and
(B) in X-ray diffraction using a CuKα ray, the sulfide solid electrolyte has a diffraction peak for which 2θ is 20.1±0.4°.
8. The production method according to 7, wherein the sulfide solid electrolyte has an average particle size of 10 μm or less.
9. The production method according to 7 or 8, the method further comprising: a step of mechanically mixing sulfur and titanium disulfide to synthesize the titanium sulfide.
10. A positive electrode mixture obtained by the production method according to any one of 7 to 9.
11. A positive electrode comprising the positive electrode mixture according to any one of 1 to 6 and 10.
12. A lithium-ion battery comprising the positive electrode according to 11.

According to the present invention, a positive electrode mixture using titanium polysulfide, which enables a lithium-ion battery having a high discharge capacity, can be provided.

### BRIEF DESCRIPTION OF DRAWINGS

FIG. 1 is an X-ray diffraction (XRD) chart of a sulfide solid electrolyte powder A, a positive electrode mixture of Example 1, a sulfide solid electrolyte powder C, and a positive electrode mixture of Comparative Example 2.

FIG. 2 is an XRD chart of a sulfide solid electrolyte powder B and a positive electrode mixture produced in Comparative Example 1.

FIG. 3 is an XRD chart of a positive electrode mixture produced in Example 2.

FIG. 4 is an XRD chart of sulfur, titanium disulfide, a positive electrode active material B, and a positive electrode active material C.

FIG. 5 is an XRD chart of a sulfide solid electrolyte powder D.

FIG. 6 is an XRD chart of a positive electrode mixture produced in Example 3.

FIG. 7 is an XRD chart of a positive electrode mixture produced in Example 4.

FIG. 8 is an XRD chart of each positive electrode mixture produced in Examples 5 to 7.

### DESCRIPTION OF EMBODIMENTS

Hereinafter, an embodiment of the present invention (hereinafter referred to as “the present embodiment” in some cases) will be described. In the present specification, the numerical values of the upper limit and the lower limit regarding the numerical ranges of “equal to or more than”, “equal to or less than”, and “to” are numerical values that can be combined in any manner, and the numerical values of Examples can also be used as the numerical values of the upper limit and the lower limit.

### 1. Positive Electrode Mixture

A positive electrode mixture according to one embodiment of the present invention contains at least one of a titanium sulfide TiSₓ (2<x<10) and a discharge product of the titanium sulfide (hereinafter, the titanium sulfide and the discharge product thereof will be collectively referred to as the titanium polysulfide in some cases) and a sulfide solid electrolyte having a diffraction peak for which 2θ is 20.1±0.4° in X-ray diffraction using a CuKα ray.

The sulfide solid electrolyte is a glass-ceramic having a peak at a predetermined position in powder X-ray diffraction (XRD) measurement. The use of the sulfide solid electrolyte in combination with the titanium polysulfide enables a positive electrode mixture to provide a lithium-ion battery having a high discharge capacity.

Hereinafter, constituent members of the positive electrode mixture of the present embodiment will be described.

### [Sulfide Solid Electrolyte]

The sulfide solid electrolyte used in the present embodiment is a glass-ceramic having a diffraction peak for which 2θ is 20.1±0.4° in XRD measurement. In the present application, a glass-ceramic solid electrolyte shall mean a solid electrolyte from which peaks derived from the solid electrolyte are observed in XRD measurement, regardless of whether or not peaks derived from raw materials of the solid electrolyte are also observed. That is, the glass-ceramic solid electrolyte includes a crystal structure derived from a solid electrolyte, and a part thereof may have a crystal structure derived from the solid electrolyte or the whole thereof may have a crystal structure derived from the solid electrolyte. In addition, the glass-ceramic solid electrolyte may contain an amorphous component (also referred to as “glass component”) in a part as long as the glass-ceramic solid electrolyte has an X-ray diffraction pattern as described above. In the glass-ceramic solid electrolyte, a so-called glass-ceramic obtained by heating an amorphous solid electrolyte (glass component) to the crystallization temperature or higher is contained.

In the present embodiment, the peak derived from the solid electrolyte is a diffraction peak with 2θ at 20.1±0.4°. In addition, diffraction peaks with 2θ=23.5±0.4°, 37.1±0.8°, and 40.7±0.8° can also be used as the peak derived from the solid electrolyte to specify the sulfide solid electrolyte. Not all of the peaks described above need to be observed, and the sulfide solid electrolyte may be specified with the diffraction peak with 2θ=20.1±0.4° and at least one of the other peaks.

In one embodiment, the sulfide solid electrolyte contains lithium, phosphorus, sulfur, and halogen as constituent elements. The halogen (X) preferably includes one or more selected from fluorine (F), chlorine (Cl), bromine (Br), and iodine (I) and more preferably includes Br or I. In addition, the halogen (X) preferably includes I.

The type and molar ratio of the constituent elements of the sulfide solid electrolyte can be confirmed by, for example, an ICP emission spectroscopic analyzer.

The molar ratio of the constituent elements of the sulfide solid electrolyte can be adjusted by controlling the blending of raw materials. The molar ratio of the constituent elements in the raw material is substantially equal to the molar ratio of the constituent elements in the sulfide solid electrolyte to be obtained.

The sulfide solid electrolyte of the present embodiment can be produced by, for example, mixing and pulverizing a starting raw material of a known lithium ion sulfide solid electrolyte so that the molar ratio of constituent elements satisfies a predetermined range to produce glass, and further performing a heat treatment to produce a ceramic.

As the raw material of the sulfide solid electrolyte, two or more types of compounds or simple substances containing, as constituent elements, lithium, phosphorus, sulfur, and halogen can be used in combination, and any raw material can be employed with no particular limitations as long as the raw material exhibits ion conductivity attributed to a metal atom contained.

Examples of a raw material containing lithium (Li) include lithium compounds such as lithium sulfide (Li₂S), lithium oxide (Li₂O), and lithium carbonate (Li₂CO₃), lithium metal simple substances, and the like. Among these, the lithium compounds are preferable, and lithium sulfide is more preferable.

The lithium sulfide can be used without particular limitation, but a high-purity lithium sulfide is preferable. Lithium sulfide can be produced, for example, by the methods described in JP H7-330312 A, JP H9-283156 A, JP 2010-163356 A, and JP 2011-84438 A.

Specifically, lithium hydroxide and hydrogen sulfide are reacted in a hydrocarbon-based organic solvent at 70° C. to 300° C. to generate lithium hydrosulfide, and this reaction liquid is then subjected to dehydrodesulfurization to synthesize lithium sulfide (JP 2010-163356 A).

In addition, lithium hydroxide and hydrogen sulfide are reacted in an aqueous solvent at 10° C. to 100° C. to generate lithium hydrosulfide, and this reaction liquid is then subjected to dehydrodesulfurization to synthesize lithium sulfide (JP 2011-84438 A).

Examples of the raw material containing phosphorus (P) include phosphorus sulfide such as diphosphorus trisulfide (P₂S₃) and diphosphorus pentasulfide (P₂S₅), phosphorus compounds such as sodium phosphate (Na₃PO₄), and phosphorus simple substance. Among them, phosphorus sulfide is preferable, and diphosphorus pentasulfide (P₂S₅) is more preferable. The phosphorus compound, such as diphosphorus pentasulfide (P₂S₅), and the phosphorus simple substance can be used without particular limitation as long as the phosphorus compound and the phosphorus simple substance are industrially produced and sold.

As the raw material containing the halogen (X), for example, a halogen compound represented by the following formula is preferably contained.

Mₗ-Xₘ

In the formula, M represents sodium (Na), lithium (Li), boron (B), aluminum (Al), silicon (Si), phosphorus (P), sulfur(S), germanium (Ge), arsenic (As), selenium (Se), tin (Sn), antimony (Sb), tellurium (Te), lead (Pb), bismuth (Bi), or a combination of these elements with an oxygen element or a sulfur element, lithium (Li) or phosphorus (P) is preferable, and lithium (Li) is more preferable.

X is a halogen element selected from fluorine (F), chlorine (Cl), bromine (Br), and iodine (I).

In addition, l is an integer of 1 or 2, and m is an integer of 1 to 10. When m is an integer of 2 to 10, that is, when a plurality of X's exist, X's may be the same or may be different. For example, in SiBrCl₃, which will be described below, m is 4, and X is composed of different elements Br and Cl.

Specific examples of the halogen compound represented by the formula include: sodium halides such as NaI, NaF, NaCl, and NaBr; lithium halides such as LiF, LiCl, LiBr, and LiI; boron halides such as BCl₃, BBr₃, and Bl₃; aluminum halides such as AlF₃, AlBr₃, AlI₃, and AlCl₃; silicon halides such as SiF₄, SiCl₄, SiCl₃, Si₂Cl₆, SiBr₄, SiBrCl₃, SiBr₂Cl₂, and SiI₄; phosphorus halide such as PF₃, PF₅, PCl₃, PCl₅, POCl₃, PBr₃, POBr₃, PI₃, P₂Cl₄, and P₂I₄; sulfur halides such as SF₂, SF₄, SF₆, S₂F₁₀, SCl₂, S₂Cl₂, and S₂Br₂; germanium halides such as GeF₄, GeCl₄, GeBr₄, GeI₄, GeF₂, GeCl₂, GeBr₂, and GeI₂; arsenic halides such as AsF₃, AsCl₃, AsBr₃, AsI₃, and AsF₅; selenium halides such as SeF₄, SeF₆, SeCl₂, SeCl₄, Se₂Br₂, and SeBr₄; tin halides such as SnF₄, SnCl₄, SnBr₄, SnI₄, SnF₂, SnCl₂, SnBr₂, or SnI₂; antimony halide such as SbF₃, SbCl₃, SbBr₃, Sbl₃, SbF₅, or SbCl₅; tellurium halides such as TeF₄, Te₂F₁₀, TeF₆, TeCl₂, TeCl₄, TeBr₂, TeBr₄, and TeI₄; lead halides such as PbF₄, PbCl₄, PbF₂, PbCl₂, PbBr₂, and PbI₂; and bismuth halides such as BiF₃, BiCl₃, BiBr₃, and BiI₃.

Among them, preferable examples include lithium halides such as lithium chloride (LiCl), lithium bromide (LiBr), and lithium iodide (LiI), and phosphorus halides such as phosphorus pentachloride (PCl₅), phosphorus trichloride (PCl₃), phosphorus pentabromide (PBr₅), and phosphorus tribromide (PBr₃). Among them, lithium halides such as LiCl, LiBr, and LiI, and PBr₃ are preferable, lithium halides such as LiCl, LiBr, and LiI are more preferable, and LiI and LiBr are still more preferable.

As the halogen compound, one type from the above-described compounds may be used singly, or two or more types may be used in combination. That is, at least one of the above-described compounds can be used.

In the present embodiment, the raw material preferably contains a lithium compound, a phosphorus compound, and one or more types of halogen compounds, at least one of the lithium compound and the phosphorus compound containing a sulfur element, and is more preferably a combination of lithium sulfide, phosphorus sulfide, and one or two or more types of lithium halides.

For example, in a case where lithium sulfide, phosphorus pentasulfide, and lithium halide are used as the raw material of the sulfide solid electrolyte, the molar ratio between lithium sulfide and phosphorus pentasulfide in the molar ratio of the raw materials injected is preferably 65 to 85:15 to 35, more preferably 70 to 80:20 to 30, still more preferably 72 to 78:22 to 28, and particularly preferably 75:25.

In addition, in a case where Li₂S, P₂S₅, and LiX are used as the raw materials of the sulfide solid electrolyte, the total content rate ([Li₂S+P₂S₅]×100/[Li₂S+P₂S₅+LiX]) of lithium sulfide and phosphorus pentasulfide is preferably 60 to 95 mol %, more preferably 65 to 90 mol %, and still more preferably 70 to 85 mol %.

In one embodiment, the content rate of lithium with respect to all of the constituent elements of the sulfide solid electrolyte is 35 to 45 mol %. The positive electrode mixture provides a battery having a high discharge capacity, even though the content rate of lithium is lower than, for example, that of a solid electrolyte having an argyrodite type crystal structure.

In the present embodiment, the above-described raw materials are reacted by applying mechanical stress thereto, and an intermediate (glassy powder) is produced. Here, “applying mechanical stress” refers to mechanically applying a shear force, an impact force, or the like. Examples of the means for applying the mechanical stress include a pulverizer such as a planetary ball mill, a vibration mill, or a rolling mill, and a kneader. By strong mechanical stress, at least a part of the raw material powders is ground and mixed until crystallinity cannot be maintained.

As conditions for pulverizing and mixing, for example, when a planetary ball mill is used as a pulverizer, the treatment may be performed for 0.5 hours to 100 hours at a rotation speed of several tens to several hundreds of revolutions/min. More specifically, in the case of the planetary ball mill (manufactured by Fritsch, model number P-7) used in Examples of the present application, the rotation speed of the planetary ball mill is preferably 100 rpm or more and 500 rpm or less, and more preferably 150 rpm or more and 450 rpm or less.

In the case of using, for example, a zirconia ball, the diameter of the ball, which is the pulverizing medium, is preferably 0.2 to 20 mm.

The temperature during pulverizing is not particularly specified, but is preferably 200° C. or lower in order to prevent the solid electrolyte itself from crystallizing and curing.

The intermediate produced by pulverizing and mixing is subjected to a heat treatment. Specifically, the heating temperature of the intermediate may be set within a range of preferably 5° C. or lower, more preferably 10° C. or lower, and still more preferably 15° C. or lower, starting from a temperature (T_{c1}) of a peak top of an exothermic peak observed at the lowest temperature side when simultaneous thermogravimetric-differential thermal analysis (TGDTA) is performed on the intermediate under a temperature rise condition of 10° C./min using a simultaneous thermogravimetric-differential thermal analysis apparatus (TGDTA apparatus), and the lower limit is not particularly limited, but may be set to about the temperature of the peak top of the exothermic peak observed at the lowest temperature side −10° C. or higher. When the temperature range is set as described above, the sulfide solid electrolyte (glass-ceramic solid electrolyte) used in the present embodiment can be obtained more efficiently.

The heating temperature for obtaining the glass-ceramic solid electrolyte of the present embodiment cannot be generally defined, but is usually preferably 250° C. or lower, more preferably 225° C. or lower, still more preferably 200° C. or lower, and the lower limit is not particularly limited, but is preferably 100° C. or higher, more preferably 110° C. or higher, and still more preferably 120° C. or higher.

The heating time is not particularly limited as long as a desired glass-ceramic solid electrolyte can be obtained, but is, for example, preferably 10 minutes or longer, more preferably 30 minutes or longer, still more preferably 60 minutes or longer, and far still more preferably 2 hours or longer. In addition, the upper limit of the heating time is not particularly limited, but is preferably 10 hours or shorter, more preferably 8 hours or shorter, still more preferably 6 hours or shorter, and still more preferably 4 hours or shorter.

The atmosphere for the heat treatment is not particularly limited, and may be in a hydrogen sulfide stream, in an inert gas atmosphere such as nitrogen or argon, or in a vacuum atmosphere.

$$[ Titanium sulfide {TiS}_{x} ( 2 < x < 10 ) ]$$

The titanium sulfide is not particularly limited, and known titanium sulfides can be used. Specific examples thereof include titanium sulfides disclosed in Patent Document 1, produced by mixing and pulverizing crystalline TiS₂ and sulfur as raw materials by a mechanical milling method.

In one embodiment, the titanium sulfide is amorphous or crystalline. A crystalline titanium sulfide has a diffraction peak for which 2θ is 34±1° and a diffraction peak for which 2θ is one or more selected from 15.5±1°, 44±1°, and 54±1° in X-ray diffraction using a CuKα ray.

The above-described diffraction peaks are derived from titanium disulfide crystals, and are a diffraction peak with a diffraction angle 2θ=15.5±1° based on the (001) plane of the TiS₂ crystals, a diffraction peak with 2θ=34±1° based on the (011) plane, a diffraction peak with 2θ=44±1° based on the (102) plane, and a diffraction peak with 2θ=54±1° based on the (110) plane. The synthesis of the titanium sulfide will be described later.

The titanium sulfide partially or fully changes to a discharge product during a battery reaction. Therefore, in the positive electrode mixture (positive electrode) of one embodiment, a discharge product of the titanium sulfide is present.

Examples of the discharge product of the titanium sulfide include substances in which the titanium sulfide has been lithiated and which contain Li as an element.

### Others

In one embodiment of the present invention, the positive electrode mixture preferably further contains a conductive aid.

The conductive aid may be any material having electron conductivity. The conductive aid preferably has a plurality of pores and a high specific surface area. Particularly preferable, the conductive aid is a porous carbon material. Since the carbon material has high conductivity and is lighter than other conductive materials, the power density and electrical capacity per weight of a battery can be increased.

The specific surface area of the conductive aid is preferably 0.1 m²/g or more and 5,000 m²/g or less, more preferably 1 m²/g or more and 4,000 m²/g or less, still more preferably 1 m²/g or more and 3,000 m²/g or less, and most preferably 10 m²/g or more and 3,000 m²/g or less.

The pore volume of the conductive aid is preferably 0.1 cc/g or more and 5.0 cc/g or less.

The pores of the conductive aid preferably have an average diameter of 0.1 nm or more and 40 nm or less, more preferably 0.5 nm or more and 40 nm or less, still more preferably 0.5 nm or more and 20 nm or less, and most preferably 1 nm or more and 20 nm or less.

The specific surface area, the pore volume, and the pore diameter of the conductive aid can be determined using a nitrogen adsorption isotherm obtained by adsorbing nitrogen gas to the conductive aid at a liquid nitrogen temperature. Specifically, the specific surface area can be calculated by the Brunauer-Emmet-Teller (BET) multipoint method using a nitrogen adsorption isotherm. The pore volume and the pore diameter can be determined by the Barrett-Joyner-Halenda (BJH) method using a nitrogen adsorption isotherm.

As a measuring device, for example, a specific surface area/pore distribution measuring device (Autosorb-3) manufactured by Quantachrome Instruments can be used for measurement.

The carbon material is not particularly limited, and examples thereof include carbon blacks such as Ketjen black, acetylene black, Denka black, thermal black, and channel black, mesoporous carbon, activated carbon, amorphous carbon, carbon nanotubes, vapor grown carbon fiber (VGCF), carbon nanohorn, and the like, and examples of conductive carbon materials include fullerene, carbon fiber, natural graphite, artificial graphite, graphene, graphene oxide, reduced graphene oxide, and the like. Among them, activated carbon is preferable. In addition, these may be used singly, or two or more types thereof may be used in combination. In addition, a composite material thereof may also be used.

In one embodiment, a content rate a of the titanium sulfide in the positive electrode mixture, a content rate b of the sulfide solid electrolyte, and a content rate c of the conductive aid preferably satisfy the following formulae (1) to (3).

$$10 mass \% \leq a \leq 90 mass \% \qquad ( 1 )$$

$$0 mass \% < b \leq 65 mass \% \qquad ( 2 )$$

$$0 mass \% \leq c \leq 40 mass \% \qquad ( 3 )$$

$$( a + b + c is 100 mass \% . )$$

By satisfying the formulae (1) to (3), a battery having a high discharge capacity can be obtained. The content rate a of the titanium sulfide is more preferably 30 mass % or more and still more preferably 60 mass % or more. In addition, the content rate is more preferably 85 mass % or less.

The content rate b of the sulfide solid electrolyte is more preferably 10 mass % or more and still more preferably 15 mass % or more. In addition, the content rate is more preferably 50 mass % or less.

The content rate c of the conductive aid is more preferably 30 mass % or less and still more preferably 10 mass % or less. In addition, the content rate may be 0 mass %. That is, a high-performance positive electrode mixture can be obtained even without using a conductive aid.

In one embodiment, the positive electrode mixture may or may not include other components in addition to the titanium polysulfide, the sulfide solid electrolyte, and the conductive aid described above. The other components are not particularly limited, and examples thereof include a binder, a solvent, and a dispersant.

The positive electrode mixture according to the present embodiment can be produced, for example, by a method described below.

### 2. Production Method for Positive Electrode Mixture

A production method for a positive electrode mixture according to one embodiment of the present invention includes a step of mixing a titanium sulfide TiSₓ (2<x<10) satisfying the following (A) and a sulfide solid electrolyte satisfying the following (B):
(A) in X-ray diffraction using a CuKα ray, the titanium sulfide has a diffraction peak for which 2θ is 34±1° and a diffraction peak for which 2θ is one or more selected from 15.5±1°, 44±1°, and 54±1°, and
(B) in X-ray diffraction using a CuKα ray, the sulfide solid electrolyte has a diffraction peak for which 2θ is 20.1±0.4°.

As described above, the above-described (A) means that the titanium sulfide contains titanium disulfide crystals. The above-described (B) means that the sulfide solid electrolyte is a predetermined glass-ceramic. In the present embodiment, the above-described titanium sulfide and the sulfide solid electrolyte are mixed, whereby a positive electrode mixture that enables a lithium-ion battery having a high discharge capacity can be produced.

In one embodiment, in order to synthesize the above-described titanium sulfide, a step of mechanically mixing sulfur and titanium disulfide (TiS₂) is included.

TiS₂ used as a raw material is not particularly limited, and any commercially available TiS₂ can be used. In particular, high-purity TiS₂ is preferably used.

Sulfur used as a raw material is also not particularly limited, and any crystalline sulfur can be used as long as the sulfur is solid at normal temperature and normal pressure.

The ratio between TiS₂ and sulfur is set to be the same as the elemental ratio between titanium in the target titanium polysulfide and sulfur. x in TiSₓ is preferably 3 or more, or 4 or more, and is preferably 9 or less, or 8 or less. More preferably, Ti and S are mixed such that x in TiSₓ reaches 4 to 6.

The mechanical milling method can be carried out, for example, by mixing and pulverizing the raw materials using a mechanical pulverizing machine such as a ball mill, a rod mill, a vibration mill, a disk mill, a hammer mill, a jet mill, or a VIS mill.

In the mechanical milling method, the treatment is performed so that TiS₂ is not fully amorphized, leaving a small amount of fine TiS₂ crystals. The crystal state of TiS₂ can be confirmed from the position and half-width of the diffraction peak by XRD measurement.

In one embodiment, an active material-conductive aid composite material may be formed from the titanium sulfide and the conductive aid described above, and then the sulfide solid electrolyte and the active material-conductive aid composite material may be mechanically mixed.

In the present embodiment, an active material or the active material-conductive aid composite material and the sulfide solid electrolyte are mechanically mixed to form the positive electrode mixture. Through this step, a part of the active material, the active material-conductive aid composite material, and the sulfide solid electrolyte may be pulverized.

For example, in the case of the planetary ball mill (manufactured by Fritsch, model number P-7), the rotation speed of the planetary ball mill is preferably 50 rpm or more and 500 rpm or less, and more preferably 80 rpm or more and 400 rpm or less.

In the case of using, for example, a zirconia ball, the diameter of the ball, which is the pulverizing medium, is preferably 0.2 to 20 mm.

In one embodiment, the sulfide solid electrolyte has an average particle size of 10 μm or less. This makes it possible to sufficiently form an ion conduction path in the positive electrode, and a battery having a high discharge capacity can thus be obtained. The average particle size is more preferably 6 μm or less and particularly preferably 3 μm or less.

The average particle size means a median diameter (d50).

In one embodiment, it is preferable that the content rate a of the titanium sulfide in the positive electrode mixture, the content rate b of the sulfide solid electrolyte, and the content rate c of the conductive aid be adjusted to satisfy the following formulae (1) to (3).

$$10 mass \% \leq a \leq 90 mass \% \qquad ( 1 )$$

$$0 mass \% < b \leq 65 mass \% \qquad ( 2 )$$

$$0 mass \% \leq c \leq 40 mass \% \qquad ( 3 )$$

$$( a + b + c is 100 mass \% . )$$

By satisfying the formulae (1) to (3), a battery having a high discharge capacity can be obtained.

### 3. Positive Electrode and Lithium-Ion Battery

A positive electrode or a lithium-ion battery according to 1 embodiment of the present invention includes the above-described positive electrode mixture of the present invention. For example, the use of a solid electrolyte instead of a liquid electrolyte makes it possible to manufacture an all-solid-state lithium-ion battery. The use of the positive electrode mixture of the present invention makes it possible to produce an all-solid-state lithium-ion battery having a high discharge capacity.

The all-solid-state lithium-ion battery is mainly composed of a positive electrode layer, a negative electrode layer, and an electrolyte layer, and the positive electrode mixture of the present invention is suitable as a constituent material of the positive electrode layer. The negative electrode layer and the electrolyte layer can be manufactured by a known method. In addition to the positive electrode layer, the negative electrode layer, and the electrolyte layer, a current collector is preferably used, and a known current collector is also used.

The solid electrolyte is not particularly limited, and a known solid electrolyte can be used.

### EXAMPLES

Hereinafter, the present invention will be specifically described based on Examples. The present invention is not limited to the Examples. Evaluation methods for a sample produced in each of the examples will be shown below.

### (1) Ion Conductivity

A solid electrolyte was molded into a circular pellet having a diameter of 10 mm (cross-sectional area S: 0.785 cm²) and a height (L) of 0.1 to 0.3 cm to produce a sample. Electrode terminals were attached to the sample from above and below, and measurement was performed by an AC impedance method at 25° C. (frequency range: 1 MHz to 1 Hz, amplitude: 10 mV) to obtain a Cole-Cole plot. The real part Z′ (Ω) at a point at which −Z″ (Ω) became the minimum near the right end of an arc observed in a region on the high frequency side was designated as the bulk resistance R (Ω) of the electrolyte, and the ion conductivity σ (S/cm) was calculated according to the following equation.

$$R = ρ ( L / S )$$

$$σ = 1 / ρ$$

### (2) X-Ray Diffraction (XRD) Measurement

The physical properties of the sample and the presence or absence of a diffraction peak were analyzed by powder XRD measurement. In a case where there was no diffraction peak or only a peak derived from a raw material, the sample was determined to be amorphous, and in a case where there was a diffraction peak other than the raw material, the sample was determined to be crystalline.

Specifically, a powder of the sample was charged into a hole having a diameter of 20 mm and a depth of 0.2 mm, and was floated with a glass to prepare a sample. This sample was sealed with a Kapton film for XRD and subjected to measurement without contact with air.

The XRD measurement was performed under the following measurement conditions using a powder X-ray diffractometer D2 PHASER manufactured by Bruker.

### [Measurement Conditions]

Tube voltage: 30 kV
Tube current: 10 mA
X-ray wavelength: CuKα ray (1.5418 Å)
Optical system: focusing method
Slit configuration: Solar slit 4° (on both incident side and light receiving side), divergence slit 1 mm, KB filter (Ni plate 0.5%), air scatter screen 3 mm is used.
Detector: Semiconductor detector
Measurement range: 2θ=10 to 60 deg
Step width, scan speed: 0.05 deg, 0.05 deg/see

### (3) Average Particle Size

The median diameter (d50) of the solid electrolyte powder was measured using a laser diffraction/scattering particle size distribution analyzer (LA-960 manufactured by HORIBA, Ltd.).

### Example 1

### (1) Production of Positive Electrode Active Material Powder (Titanium Sulfide)

In a glove box in an argon atmosphere, a titanium disulfide (TiS₂) powder and a sulfur(S) powder were weighed so that the molar ratio reached 1:2, and sealed in a 45 mL zirconia pot together with 90 g of zirconia balls having a diameter of 4 mm. The pot was installed in a planetary ball mill (P7 Classic Line manufactured by Fritsch GmbH), and a mechanical milling treatment was performed at 510 rpm for 50 hours to obtain a positive electrode active material powder A.

### (2) Production of Sulfide Solid Electrolyte

In a glove box in an argon atmosphere, 0.4936 g of lithium sulfide, 0.7959 g of diphosphorus pentasulfide, and 0.2104 g of lithium iodide were sealed in a 45 mL zirconia pot together with 10 zirconia balls having a diameter of 10 mm. The pot was installed in a planetary ball mill (P7 Classic Line manufactured by Fritsch GmbH), and a mechanical milling treatment was performed at 370 rpm for 40 hours to obtain a powder. The obtained powder was heated at 195° C. for 3 hours to obtain a sulfide solid electrolyte powder A (glass-ceramic).

The ionic conductivity of the sulfide solid electrolyte powder A was 3.8 mScm⁻¹. The average particle size d50 was 6 μm.

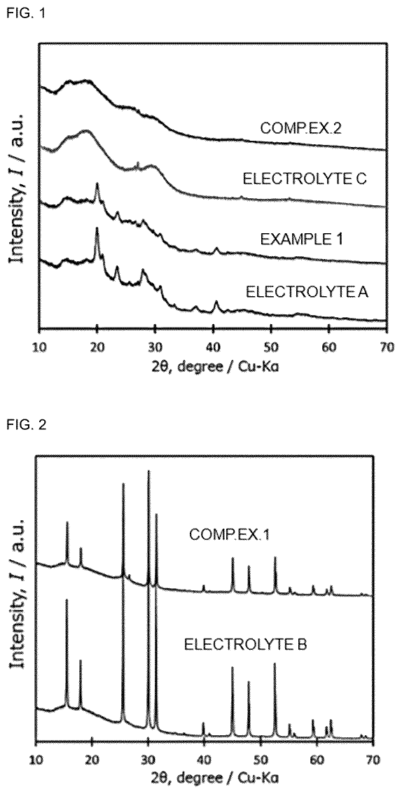

FIG. 1 shows an XRD chart of the sulfide solid electrolyte powder A (electrolyte A). Peaks derived from the solid electrolyte were observed at 2θ=20.1°, 23.5°, 37.2°, and 40.7°.

### (3) Production of Positive Electrode Mixture

The positive electrode active material powder A and acetylene black were weighed so that the mass ratio reached 50:50 and mixed for 5 minutes using an agate mortar. An obtained powder was sealed in a 45 mL zirconia pot together with 100 zirconia balls having a diameter of 5 mm and mixed in a planetary ball mill (P7 Classic Line manufactured by Fritsch GmbH) under conditions of 370 rpm and 1 hour to obtain a composite of a positive electrode active material and a conductive aid.

Subsequently, the sulfide solid electrolyte powder A was added to the pot so that the mass ratio to the composite of the positive electrode active material and the conductive aid reached 50:50, and further mixed with the planetary ball mill at 100 rpm for 30 minutes to obtain a positive electrode mixture.

FIG. 1 shows an XRD chart of the positive electrode mixture (Example 1).

(4) all-Solid-State Lithium-Ion Battery

As a production method for an all-solid-state lithium-ion battery, the positive electrode mixture was used as a working electrode, the sulfide-based solid electrolyte A was used as an electrolyte layer, and a lithium-indium alloy was used as a counter electrode. The positive electrode mixture used as the working electrode was 5 mg.

### Comparative Example 1

### (1) Production of Sulfide Solid Electrolyte

In a glove box in an argon atmosphere, 4.1414 g of lithium sulfide, 4.1739 g of diphosphorus pentasulfide, and 1.7514 g of lithium chloride were sealed in a 250 mL zirconia pot together with 40 zirconia balls having a diameter of 10 mm. The pot was installed in a planetary ball mill (P5 Classic Line manufactured by Fritsch GmbH), and mechanical milling at 220 rpm for 40 hours was performed.

The obtained powder was heated at 430° C. for 2 hours. A resultant was ground in a mortar and then collected through a sieve having an aperture of 100 μm. 2 g of the collected powder, 18.2 g of toluene, and 34 g of zirconia balls having a diameter of 2 mm were sealed in a 45 mL zirconia pot. The pot was installed in a planetary ball mill (P7 Classic Line manufactured by Fritsch GmbH), and the powder was ground at 150 rpm for 17 minutes, thereby obtaining a slurry. The obtained slurry was vacuum-dried at 120° C. for 2 hours to obtain a sulfide solid electrolyte powder B.

The ionic conductivity of the sulfide solid electrolyte powder B was 4.0 mScm⁻¹. The average particle size d50 was 6 μm.

FIG. 2 shows an XRD chart of the sulfide solid electrolyte powder B (electrolyte B). As a result of XRD measurement, the sulfide solid electrolyte powder B was an argyrodite type sulfide solid electrolyte.

(2) Production of Positive Electrode Mixture and all-Solid-State Lithium-Ion Battery

A positive electrode mixture and an all-solid-state lithium-ion battery were produced in the same manner as in Example 1 except that the sulfide solid electrolyte A was changed to the sulfide solid electrolyte B.

FIG. 2 shows the XRD measurement result of the positive electrode mixture produced in Comparative Example 1.

### Comparative Example 2

### (1) Production of Sulfide Solid Electrolyte

In a glove box in an argon atmosphere, 0.5742 g of lithium sulfide and 0.9258 g of diphosphorus pentasulfide were sealed in a 45 mL zirconia pot together with 10 zirconia balls having a diameter of 10 mm. The pot was installed in a ball mill (P7 Classic Line manufactured by Fritsch GmbH), and a mechanical milling treatment was performed at 370 rpm for 40 hours to obtain a sulfide solid electrolyte powder C.

The ionic conductivity of the sulfide solid electrolyte powder C was 0.32 mScm⁻¹. The average particle size d50 was 6 μm.

FIG. 1 shows an XRD chart of the sulfide solid electrolyte powder C (electrolyte C). As a result of XRD measurement, since there was no clear diffraction peak other than a peak based on the raw material, the sulfide solid electrolyte powder C was confirmed to be glass.

(2) Production of Positive Electrode Mixture and all-Solid-State Lithium-Ion Battery

A positive electrode mixture and an all-solid-state lithium-ion battery were produced in the same manner as in Example 1 except that the sulfide solid electrolyte A was changed to the sulfide solid electrolyte C.

FIG. 1 shows an XRD chart of the positive electrode mixture (Comparative Example 2).

### [Evaluation of Battery Characteristics]

For the all-solid-state lithium-ion batteries produced in Examples and Comparative Examples, the voltage ranges were set to 0.9 to 2.4 V vs. Li—In, the current densities were set to 0.064 mAcm⁻², and constant-current charge/discharge tests of the all-solid-state batteries were performed.

The results are shown in Table 1. In the table, the positive electrode mixture compositions (TiSₓ:SE:C) represent titanium sulfide:sulfide solid electrolyte:conductive aid (mass ratio).

TABLE 1

| | | | Presence or | Sulfide solid electrolyte used | | | | | |
|---|---|---|---|---|---|---|---|---|---|
| | x value | TiSₓ | absence of | | Proportion of | Particle | [symbol] | Positive-electrode | Discharge |
| | in | synthesis | TiS₂ crystal | | Li atoms | size | conductivity | mix composition | capacity |
| | TiSₓ | conditions | phase | Composition | (mol %) | (μm) | (mS/cm) | (TiS [symbol] :SE:C) | (mAh/g) |
| Example 1 | 4 | Ball mill | x | 80( [symbol] ) 20 [symbol] | 3 [symbol] | 6 | 3.8 | 25:50:25 | 160 |
| | | 50 h | | (glass ceramic) | | | | | |
| Comp. Ex 1 | 4 | Ball mill | x | Li [symbol] PS [symbol] | 4 [symbol] | 6 | 4.0 | 25:50:25 | 134 |
| | | 50 h | | (crystal) | | | | | |
| Comp. Ex 2 | 4 | Ball mill | x | 0.75Li₂S•0.25P₂S [symbol] | 38 | 6 | 0.32 | 25:50:25 | 119 |
| | | 50 h | | | | | | | |

[symbol]

indicates data missing or illegible when filed

In Comparative Example 1, a sulfide solid electrolyte powder B (argyrodite type sulfide solid electrolyte) having the same ionic conductivity as that of the sulfide solid electrolyte powder A (glass-ceramic) used in Example 1 was used. In addition, in Comparative Example 2, a sulfide solid electrolyte powder C (glass) having a similar proportion of Li atoms was used. As a result, it was possible to confirm that the discharge capacity per gram of the positive electrode mixture of the all-solid-state lithium-ion battery of Example 1 was high.

It is considered that the sulfide solid electrolyte powder C (glass) had a lower lithium ion conductivity and higher lithium ion conduction resistance in the positive electrode mixture than the sulfide solid electrolyte powder A (glass-ceramic), and the capacity of the battery thus became low.

On the other hand, even though the sulfide solid electrolyte powder B (argyrodite type sulfide solid electrolyte) had the same lithium ion conductivity as that of the glass-ceramic, the capacity became low.

As a cause, it is considered that the ease of cracking of the solid electrolyte particles during compositing with titanium polysulfide (TiSₓ) and the proportion of the Li element contained in the solid electrolyte are influencing.

The crystalline solid electrolyte having an argyrodite type crystal structure consists only of crystal components. Therefore, when stress is applied due to the compositing with TiSₓ, an impact is uniformly applied to all of the solid electrolyte particles, and the stress increases, whereby the solid electrolyte particles crack, and the particle sizes become small. The crystalline solid electrolyte having an argyrodite type crystal structure and a reduced particle size sufficiently comes into contact with TiSₓ during compositing, the reactivity thus becomes high, and lithium ions are supplied to TiSₓ. In addition, it is considered that a large proportion of the Li element in the crystalline solid electrolyte having an argyrodite type crystal structure is also likely to lead to a decrease in lithium ion conductivity due to an increase in reactivity or supply of lithium ions to TiSₓ, whereby the lithium ion conduction resistance in the positive electrode mixture becomes high and the discharge capacity becomes low.

On the other hand, since the glass-ceramic solid electrolyte contains a glass component, even when stress is applied due to being composited with TiSₓ, the glass component is distorted, an increase in stress is thus suppressed, and the particle size of the solid electrolyte is maintained. As a result, the glass-ceramic solid electrolyte does not sufficiently come into contact with TiSₓ as compared with the crystalline solid electrolyte having an argyrodite type crystal structure, so that lithium ions are less likely to be supplied to TiSₓ, and the lithium ion conductivity does not decrease. In addition, in the glass-ceramic solid electrolyte, since the proportion of the Li element is small, the reactivity is low, and it is assumed that the influence of the decrease in conductivity due to the supply of lithium ions is small. From what has been described above, it is considered that in the glass-ceramic solid electrolyte, the decrease in lithium ion conductivity was suppressed, and the discharge capacity became large as compared with the crystalline solid electrolyte having an argyrodite type crystal structure.

### Example 2

### (1) Production of Positive Electrode Mixture

A positive electrode mixture was obtained in the same manner as in Example 1 except that the mass ratio between the positive electrode active material powder A and acetylene black was changed to 87:13 to obtain a composite of a positive electrode active material and a conductive aid, and the mass ratio between the sulfide solid electrolyte powder A and the composite of the active material and the conductive aid was changed to 25:75.

(2) Production and Evaluation of all-Solid-State Lithium-Ion Battery

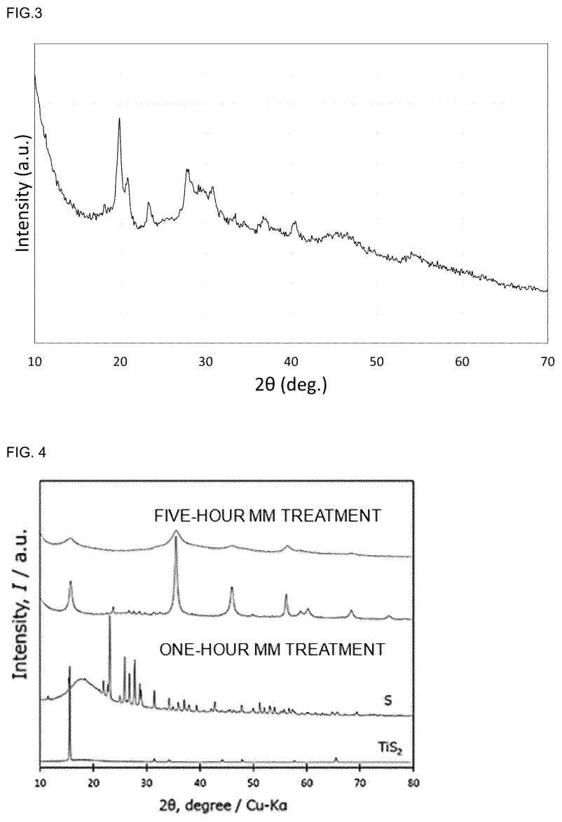

An all-solid-state lithium-ion battery was produced and evaluated in the same manner as in Example 1 except that the positive electrode mixture obtained in the above-described (1) was used. FIG. 3 shows an XRD chart of the positive electrode mixture produced in Example 2.

### Example 3

### (1) Production of Positive Electrode Active Material Powder (Titanium Sulfide)

A positive electrode active material powder B was obtained in the same manner as in Example 1 (1) except that the time of the mechanical milling treatment was changed to 5 hours. FIG. 4 shows an XRD chart of the positive electrode active material B (five-hour MM treatment). In addition, FIG. 4 shows XRD charts of a positive electrode active material C (one-hour MM treatment), which will be described below, sulfur(S), and titanium disulfide (TiS₂).

### (2) Production of Sulfide Solid Electrolyte

2 g of the sulfide solid electrolyte powder A obtained in Example 1 (2), 7 g of cyclohexane, 1 g of diisopropyl ether, and 40 g of zirconia balls having a diameter of 0.3 mm were sealed in a 45 mL zirconia pot. The pot was installed in a planetary ball mill (P7 Classic Line manufactured by Fritsch GmbH), and a mechanical milling treatment was performed at 500 rpm for 1 hour and then at 150 rpm for 1 hour to obtain a slurry. The obtained slurry was vacuum-dried at 120° C. for 2 hours, and an obtained powder was heat-treated on a hot plate at 180° C. for 2 hours to obtain a sulfide solid electrolyte powder D.

The ionic conductivity of the sulfide solid electrolyte powder D was 2.9 mScm⁻¹. The average particle size d50 was 2 μm.

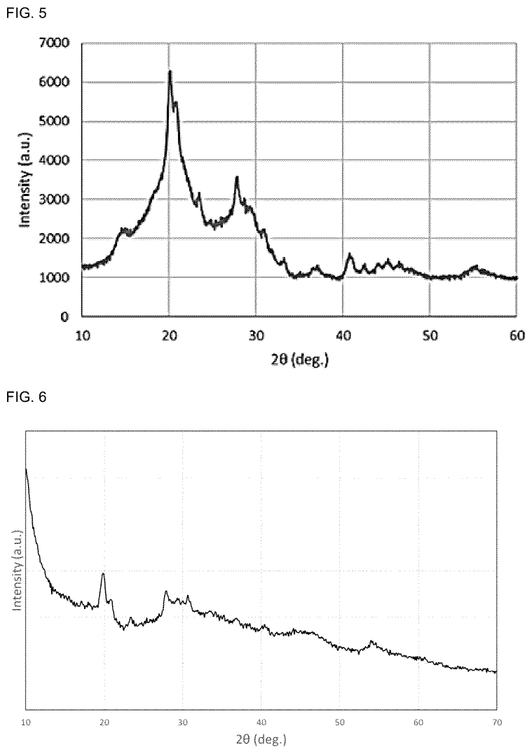

FIG. 5 shows an XRD chart of the sulfide solid electrolyte powder D. Peaks derived from the solid electrolyte were observed at 2θ=20.2°, 23.5°, 37.1°, and 40.7°.

### (3) Production of Positive Electrode Mixture

The positive electrode active material powder B and acetylene black were weighed so that the mass ratio reached 87:13 and mixed for 5 minutes using an agate mortar. An obtained powder was sealed in a 45 mL zirconia pot together with 100 zirconia balls having a diameter of 5 mm and mixed in a planetary ball mill (P7 Classic Line manufactured by Fritsch GmbH) under conditions of 370 rpm and 1 hour to obtain a composite of a positive electrode active material and a conductive aid.

Subsequently, the sulfide solid electrolyte powder D was added to the pot so that the mass ratio to the composite of the positive electrode active material and the conductive aid (electrolyte powder D:composite) reached 25:75 and further mixed with the planetary ball mill at 100 rpm for 30 minutes to obtain a positive electrode mixture.

FIG. 6 shows an XRD chart of the positive electrode mixture produced in Example 3.

(4) Production and Evaluation of all-Solid-State Lithium-Ion Battery

An all-solid-state lithium-ion battery was produced and evaluated in the same manner as in Example 1 except that the positive electrode mixture obtained in the above-described (3) was used.

### Example 4

### (1) Production of Positive Electrode Mixture

A positive electrode mixture was obtained in the same manner as in Example 3 except that the sulfide solid electrolyte powder A was used instead of the sulfide solid electrolyte powder D.

(2) Production and Evaluation of all-Solid-State Lithium-Ion Battery

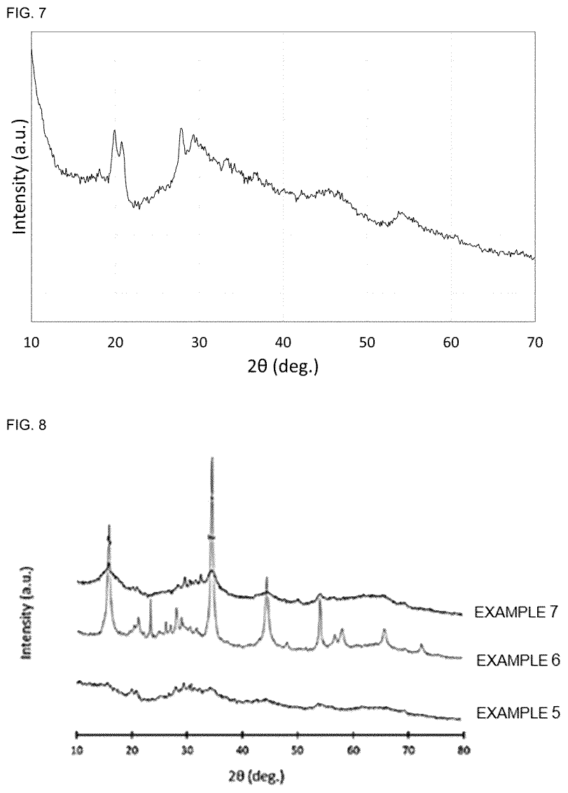

An all-solid-state lithium-ion battery was produced and evaluated in the same manner as in Example 1, except that the positive electrode mixture obtained in the above-described (1) was used. FIG. 7 shows an XRD chart of the positive electrode mixture produced in Example 4.

### Example 5

### (1) Production of Positive Electrode Active Material Powder (Titanium Sulfide)

A positive electrode active material powder C was obtained in the same manner as in Example 1 (1) except that the time of the mechanical milling treatment was changed to 1 hour.

(2) Production of Positive Electrode Mixture and all-Solid-State Lithium-Ion Battery

A positive electrode mixture and an all-solid-state lithium-ion battery were produced in the same manner as in Example 3, except that the positive electrode active material powder B was changed to the positive electrode active material powder C. FIG. 8 shows XRD charts of each positive electrode mixture produced in Examples 5 to 7.

### Example 6

### (1) Production of Positive Electrode Mixture

The positive electrode active material powder C and the sulfide solid electrolyte powder D were weighed so that the mass ratio reached 75:25, and sealed in a 45 mL zirconia pot together with 100 zirconia balls having a diameter of 5 mm. The pot was installed in a planetary ball mill (P7 Classic Line manufactured by Fritsch GmbH), and the powders were mixed together under conditions of 100 rpm for 30 minutes, thereby obtaining a positive electrode mixture.

(2) Production of all-Solid-State Lithium-Ion Battery

An all-solid-state lithium-ion battery was produced and evaluated in the same manner as in Example 1 except that the positive electrode mixture obtained in the above-described (1) was used.

### Example 7

### (1) Production of Positive Electrode Mixture

The positive electrode active material powder C and acetylene black were weighed so that the mass ratio reached 90:10 and mixed for 5 minutes using an agate mortar. An obtained powder was sealed in a 45 mL zirconia pot together with 100 zirconia balls having a diameter of 5 mm and mixed in a planetary ball mill (P7 Classic Line manufactured by Fritsch GmbH) under conditions of 370 rpm and 1 hour to obtain a composite of a positive electrode active material and a conductive aid.

Subsequently, the sulfide solid electrolyte powder D was added to the pot so that the mass ratio to the composite of the positive electrode active material and the conductive aid (solid electrolyte powder D:composite) reached 17:83 and was further mixed with the planetary ball mill at 100 rpm for 30 minutes to obtain a positive electrode mixture.

(2) Production of all-Solid-State Lithium-Ion Battery

An all-solid-state lithium-ion battery was produced and evaluated in the same manner as in Example 1, except that the positive electrode mixture obtained in the above-described (1) was used.

### Example 8

### (1) Production of Positive Electrode Active Material Powder (Titanium Sulfide)

In a glove box in an argon atmosphere, a titanium disulfide (TiS₂) powder and a sulfur(S) powder were weighed so that the molar ratio reached 1:4, and sealed in a 45 mL zirconia pot together with 90 g of zirconia balls having a diameter of 4 mm. The pot was installed in a planetary ball mill (P7 Classic Line manufactured by Fritsch GmbH), and a mechanical milling treatment was performed at 510 rpm for 1 hour to obtain a positive electrode active material powder D.

### (2) Production of Positive Electrode Mixture

A positive electrode mixture was obtained in the same manner as in Example 7, except that the positive electrode active material powder D obtained in the above-described (1) was used.

(3) Production of all-Solid-State Lithium-Ion Battery

An all-solid-state lithium-ion battery was produced and evaluated in the same manner as in Example 1, except that the positive electrode mixture obtained in the above-described (2) was used.

The results of evaluating the batteries produced in Examples 2 to 8 in the same manner as in Example 1 are shown in Table 2.

TABLE 2

| | | | Presence or | Sulfide solid electrolyte used | | | | | |
|---|---|---|---|---|---|---|---|---|---|
| | x value | TiSₓ | absence of | | Proportion of | Particle | [symbol] | Positive-electrode | Discharge |
| | in | synthesis | TiS₂ crystal | | Li atoms | size | conductivity | mix composition | capacity |
| | TiSₓ | conditions | phase | Composition | (mol %) | (μm) | (mScm [symbol] ) | (TiS [symbol] :SE:C) | (mAh/g) |
| Example 2 | 4 | Ball mill | x | 80(0.75Li₂S•0.25P₂S [symbol] ) 20 [symbol] | 38 | 6 | 3. [symbol] | [symbol] :10 | 183 |
| | | 50 h | | | | | | | |
| Example 3 | 4 | Ball mill | ∘ | 80(0.75Li₂S•0.25P₂S [symbol] ) 20 [symbol] | 38 | 2 | 2.9 | [symbol] :10 | 377 |
| | | 5 h | | | | | | | |
| Example 4 | 4 | Ball mill | ∘ | 80(0.75Li₂S•0.25P₂S [symbol] ) 20 [symbol] | 38 | 6 | 3.8 | [symbol] :25:10 | 221 |
| | | 5 h | | | | | | | |
| Example 5 | 4 | Ball mill | ∘ | 80(0.75Li₂S•0.25P₂S [symbol] ) 20 [symbol] | 38 | 2 | 2.9 | 75:25:10 | 364 |
| | | 1 h | | | | | | | |
| Example 6 | 4 | Ball mill | ∘ | 80(0.75Li₂S•0.25P₂S [symbol] ) 20 [symbol] | 38 | 2 | 2.9 | 75:25:0 | 3 [symbol] |
| | | 1 h | | | | | | | |
| Example 7 | 4 | Ball mill | ∘ | 80(0.75Li₂S•0.25P₂S [symbol] ) 20 [symbol] | 38 | 2 | 2.9 | 75:17:8 | 450 |
| | | 1 h | | | | | | | |
| Example 8 | 6 | Ball mill | ∘ | 80(0.75Li₂S•0.25P₂S [symbol] ) 20 [symbol] | 38 | 2 | 2.9 | 75:17:8 | 500 |
| | | 1 h | | | | | | | |

[symbol]

indicates data missing or illegible when filed

It was possible to confirm that the use of the titanium sulfide in which the TiS₂ crystal phase having a high electron conductivity remained further increases the discharge capacity.

In addition, it was confirmed that since the titanium sulfide itself, which is a positive electrode active material, has electron conductivity and lithium ion conductivity, the amount of the conductive aid or the sulfide solid electrolyte that is blended into the positive electrode mixture can be reduced.

### INDUSTRIAL APPLICABILITY

The positive electrode mixture of the present invention is suitable as a constituent material of a lithium-ion battery. In addition, the lithium-ion battery of the present invention is suitably used for, for example, batteries that are used for information related devices such as personal computers, video cameras, and mobile phones, communication devices, and vehicles such as electric vehicles.

Although only some exemplary embodiments and/or examples of this invention have been described in detail above, those skilled in the art will readily appreciate that many modifications are possible in the exemplary embodiments and/or examples without materially departing from the novel teachings and advantages of this invention. Accordingly, all such modifications are intended to be included within the scope of this invention.

The documents described in the specification and the specification of Japanese application(s) on the basis of which the present application claims Paris convention priority are incorporated herein by reference in their entirety.

1. A positive electrode mixture comprising:
at least one of a titanium sulfide TiSₓ (2<x<10) and a discharge product of the titanium sulfide; and
a sulfide solid electrolyte having a diffraction peak for which 2θ is 20.1±0.4° in X-ray diffraction using a CuKα ray.

2. The positive electrode mixture according to claim 1, wherein the sulfide solid electrolyte comprises lithium, phosphorus, sulfur, and halogen as constituent elements.

3. The positive electrode mixture according to claim 1, wherein a content rate of lithium relative to all of the constituent elements of the sulfide solid electrolyte is 35 to 45 mol %.

4. The positive electrode mixture according to claim 1, wherein a content rate a of the titanium sulfide, a content rate b of the sulfide solid electrolyte, and a content rate c of a conductive aid satisfy the following formulae (1) to (3).
$$10 mass \% \leq a \leq 90 mass \% \qquad ( 1 )$$
$$0 mass \% < b \leq 65 mass \% \qquad ( 2 )$$
$$0 mass \% \leq c \leq 40 mass \% \qquad ( 3 )$$
$$( a + b + c is 100 mass \% . )$$

5. The positive electrode mixture according to claim 1, wherein in X-ray diffraction using a CuKα ray,
the positive electrode mixture has a diffraction peak for which 2θ is 20.1±0.4°, a diffraction peak for which 2θ is 34±1°, and
a diffraction peak for which 2θ is one or more selected from 15.5±1°, 44±1°, and 54±1°.

6. The positive electrode mixture according to claim 4, wherein the content rate c of the conductive aid is 0 mass %.

7. A production method for a positive electrode mixture, the method comprising a step of mixing a titanium sulfide TiSₓ (2<x<10) that satisfies the following (A) and a sulfide solid electrolyte that satisfies the following (B):
(A) in X-ray diffraction using a CuKα ray, the titanium sulfide has a diffraction peak for which 2θ is 34±1° and a diffraction peak for which 2θ is one or more selected from 15.5±1°, 44±1°, and 54±1°, and
(B) in X-ray diffraction using a CuKα ray, the sulfide solid electrolyte has a diffraction peak for which 2θ is 20.1±0.4°.

8. The production method according to claim 7, wherein the sulfide solid electrolyte has an average particle size of 10 μm or less.

9. The production method according to claim 7, the method further comprising a step of mechanically mixing sulfur and titanium disulfide to synthesize the titanium sulfide.

10. A positive electrode mixture obtained by the production method according to claim 7.

11. A positive electrode comprising the positive electrode mixture according to claim 1.

12. A lithium-ion battery comprising the positive electrode according to claim 11.
